(19) United States
(12) Patent Application Publication
(10) Pub. No.: US 2026/0298210 A1
(43) Pub. Date: Oct. 1, 2026

(54) METHOD FOR REPLACING TENSION ADJUSTING COMPONENT USED IN A CABLE SUPPORT ASSEMBLY ON A WIND TURBINE

(71) Applicant: Vestas Wind Systems A/S, Aarhus N. (DK)

(72) Inventors: Peter Fynbo, Risskov (DK); Peter Nordlyng, Hadsund (DK); Peter Bøttcher, Egå (DK); Simon Ravnsbæk-Toft, Højbjerg (DK); Jens Torborg, Årre (DK); Jesper Hermann Hansen, Varde (DK)

(73) Assignee: Vestas Wind Systems A/S, Aarhus N. (DK)

(21) Appl. No.: 19/479,805

(22) PCT Filed: Apr. 30, 2024
(86) PCT No.: PCT/DK2024/050099

§ 371 Date: Oct. 29, 2025

(30) Foreign Application Priority Data
May 3, 2023 (DK) PA 2023 70214

(51) Int. Cl. F03D 80/50; F03D 1/06; F03D 13/40

(52) U.S. Cl. CPC F03D 80/507; F03D 13/40; F03D 1/0658; F05B 2230/80; F05B 2260/02

(57) ABSTRACT

A method is provided of replacing a tension adjusting component (44) included in a cable support assembly (30) connected with a plurality of wind turbine blades (26) on a wind turbine (10). The method includes releasing tension in the cable support assembly (30), disconnecting a tension cable (36) from a free end (46) of the tension adjusting component (44) located away from the hub (24), and securing the tension cable (36) to the wind turbine (10). A second end (48) of the tension adjusting component (44) located within the hub (24) is connected to a hoisting device (72), and also disconnected from the hub (24 ). The hoisting device (72)—which may include a winch (73) or jib crane (82), and a lift cable (74)—is then used to lower the tension adjusting component (44) down to the ground surface, where a replacement tension adjusting component (44a) is connected to the hoisting device (72). The method further includes lifting the replacement tension adjusting component (44a) back to the lab (24) using the hoisting device (72) and reconnecting it to the cable support assembly (30) and to the hub (24). Such method avoids the need to conduct repairs on the tension adjusting component (44) while that component (44) is at the top of the tower (12) of the wind turbine (10), and also while avoiding needs for a large offsite crane to perform any of these movements.

### TECHNICAL FIELD

The invention relates generally to wind turbines, and more particularly relates to a method for replacing a component that is used to set and control the tension of rotor support cables mounted to a plurality of wind turbine blades on the wind turbine, specifically without necessitating use of large external/offsite equipment moved to the wind turbine.

### BACKGROUND

Wind turbines are used to produce electrical energy using a renewable resource and without combusting a fossil fuel. Generally, a wind turbine converts kinetic energy from the wind into electrical power. A conventional wind turbine installation includes a foundation, a tower supported by the foundation, and an energy generating unit positioned atop of the tower. The energy generating unit typically includes one or more nacelles to house several mechanical and electrical components, such as a generator, gearbox, and main bearing, and the wind turbine also includes a rotor operatively coupled to the components in the nacelle through a main shaft extending from the nacelle or an alternative operative connection, as known in this art. Single rotor wind turbines and multi-rotor wind turbines (which may have multiple nacelles) are known, but for the sake of efficiency, the following description refers primarily to single rotor designs. The rotor, in turn, includes a central hub and a plurality of blades extending radially therefrom and configured to interact with the wind to cause rotation of the rotor. The rotor is supported on the main shaft (when present), which is either directly or indirectly operatively coupled with the generator which is housed inside the nacelle. Consequently, as wind forces the blades to rotate, electrical energy is produced by the generator. Wind power has seen significant growth over the last few decades, with many wind turbine installations being located both on land and offshore.

Wind turbine manufacturers continually strive to increase power production from wind turbines. In this regard, the design of the wind turbine often plays a significant role in the power output generated from the wind. For example, energy obtained from the wind is generally proportional to the sweep area of the blades. Because longer blades trace a larger area with their blade tips than shorter blades, the swept area of the rotor can be increased by using longer blades. Thus, all else being equal, more energy can be extracted from a given amount of wind by a single rotor wind turbine having longer blades than one with shorter blades. However, the continued increase in the length of the blades has certain practical limits and poses significant design challenges for wind turbine manufacturers.

For example, the increased blade weight and root diameter associated with longer blades pose design challenges that can limit maximum blade length. One specific limiting factor is the need to support an increasingly heavier blade at its rotor attachment point. Increased loading at the root magnifies fatigue at this location due to rotation and yawing of the rotor during operation of the wind turbine. Increasing blade length, root diameter, and weight also makes transportation of blades to wind turbine sites more difficult.

One design solution that enables increased blade length is to support the blades with cables. The two main sources of blade loading in wind turbines are wind and gravity, with wind generally producing flapwise moments at the blade root, and gravity generally producing edgewise moments at the blade root. Cable-supported rotors include a system of cables (hereinafter referred to as a cable support assembly) that couples the blades to each other in a manner that reduces these loads. Thus, cable-supported rotors can generally use longer blades than rotors lacking cable supports for a given set of root size and blade weight design parameters. For example, a cable-supported rotor having a given bolt circle diameter at the hub-to-blade connection can typically have longer blades than a rotor having the same bolt circle diameter that is not cable-supported. By enabling increased sweep areas, cable-supported rotors may allow wind turbines to produce more energy than would otherwise be possible. One such known design of a cable-supported wind turbine is shown in PCT published application WO2022/128040, which is owned by the original Applicant of the present application.

At the time wind turbines including cable-supported rotors are commissioned, technicians typically adjust the support cables so that they apply a predetermined amount of tension to support the loads on the blades. These adjustments can further be done using tension adjusting mechanisms located in the cable support assembly. The tension adjusting mechanisms or components can be operatively connected to a controller of the wind turbine for making adjustments in time to maintain desired levels of tension support applied to the blades by the support cables-thereby to account for variations caused over time during wind turbine operations (so-called “creep” or otherwise, as explained further below). Because deviations from optimal cable tension can reduce the advantages of cable-supported rotors, it is important to have the tension adjusting components remain in good working order to avoid having frequent maintenance intervals and wind turbine downtime associated with making adjustments to the cable support assembly.

One current exemplary tension adjusting component is a hydraulic cylinder configured to extend or retract in length to apply differing amounts of tension to the support cables in the assembly, although other types of tension adjusting components are possible as described further below. The size of such hydraulic cylinders can be quite large, with these components potentially extending up to multiple feet in length and having significant weight as well. As a result, when such a tension adjusting component is leaking or otherwise malfunctioning, it can be logistically difficult to manage movement and/or repairs of such a component up tower. Indeed, up tower repairs can involve additional equipment or rope access technician use that may not be desirable, particularly in certain environments where wind turbines operate—furthermore, in certain locales of wind turbines including offshore installations, it is difficult and costly to provide a large crane that is sufficient for moving or replacing these large-size components from their installed positions at the top of the tower. Accordingly, there is a need for improved methods for repairing and/or replacing such components when necessary in cable-supported rotors, so as to minimize operational downtime of the wind turbine and reduce costs and logistical hurdles to repair and maintenance actions for these newer types of wind turbines.

### SUMMARY

To these and other ends, embodiments of the invention are directed to a method of replacing a tension adjusting component included in a cable support assembly connected with a plurality of wind turbine blades on a wind turbine. The method includes rotating a hub and the wind turbine blades such that the tension adjusting component to be replaced extends generally downwardly from the hub towards a ground surface and releasing tension in the cable support assembly by adjusting the tension adjusting component and/or a pitch of one or more of the blades. The method also includes disconnecting a tension cable, which connects the cable support assembly to the tension adjusting component, from a free end of the tension adjusting component located away from the hub and securing the tension cable to the wind turbine. A second end of the tension adjusting component located within the hub is connected to a hoisting device, and also disconnected from the hub. The hoisting device is then used to lower the tension adjusting component down to the ground surface, where a replacement tension adjusting component is connected to the hoisting device. The method further includes lifting the replacement tension adjusting component back to the hub using the hoisting device. The method also includes securing a second end of the replacement tension adjusting component to the hub of the wind turbine, and a first free end of the replacement tension adjusting component to the tension cable. The hoisting device is disconnected from the replacement tension adjusting component, and then the cable support assembly is re-tensioned to complete the method of replacement. Such method advantageously avoids the need to conduct repairs on the tension adjusting component while that component is at the top of the tower of the wind turbine, and also while avoiding the cost and logistics of bringing a large offsite crane to perform these movements (e.g., since the hoisting device is provided for such functions). Thus, the method improves the maintenance and operations of cable-supported wind turbines.

Several embodiments are now described in conjunction with the method of this invention, and it will be understood that each embodiment can stand on its own and/or be combined in any combination with the other features/steps in the following embodiments.

In one embodiment, the hoisting device includes a winch, with the winch including a support/movement lift cable that has a length sufficient to extend between the hub and the ground surface. The winch may be selectively mounted and secured inside the hub at a location proximate a radial opening in the hub through which the tension adjusting component extends. This positions the winch for connection with and movement of the tension adjusting component. Alternatively, the winch may be permanently installed in position for this operation, and/or the hoisting device may be defined by other components.

In one such alternative example, the hoisting device includes a jib crane permanently or temporarily connected to the wind turbine, with the jib crane including a support/movement lift cable having a length sufficient to extend between the hub and the ground surface. The jib crane may be located along the nacelle or at varying locations on the wind turbine.

In another embodiment, the method includes positioning a service platform on the wind turbine at a location proximate the free end of the tension adjusting component, specifically before the step of disconnecting the tension cable from the free end of the tension adjusting component. The method also includes removing the service platform from the location proximate the replacement tension adjusting component, specifically after the step of securing the first free end of the replacement tension adjusting component to the tension cable.

In yet another related embodiment, during the step of securing the tension cable to the wind turbine, the tension cable is secured proximate to the service platform such that operators on the service platform can move and perform this step.

In a further embodiment, the service platform is specifically defined by a service lift that is hoisted up from the ground surface along a tower of the wind turbine by support cables dropped from a nacelle of the wind turbine. The service lift is then held in position at the location proximate the free end of the tension adjusting component by each of the support cables from the nacelle and by the tower.

In another embodiment, the step of securing the tension cable to the wind turbine further includes attaching the tension cable to at least one of: a tower of the wind turbine, and a support dropped downwardly from a nacelle of the wind turbine at the top of the tower. This arrangement separates support of the tension cable from the service platform.

In a further embodiment, the method includes securing one or more tag lines to the tension adjusting component and to the replacement tension adjusting component, and further guiding and controlling movement of the tension adjusting component and the replacement tension adjusting component using the one or more tag lines. This control and guidance with the tag lines is done simultaneous to lowering and lifting movements generated by the hoisting device.

In yet another embodiment, the wind turbine includes a controller at a nacelle adjacent the hub. The controller is operatively connected to each of the wind turbine blades and each tension adjusting component in the cable support assembly. The steps of releasing tension in the cable support assembly and re-tensioning the cable support assembly are performed by the controller at the nacelle.

In one embodiment, the tension adjusting component is a hydraulic cylinder that operates to extend or retract in length to apply tension to the tension cable in the cable support assembly. In such embodiments, the step of releasing tension in the cable support assembly further includes extending the length of the hydraulic cylinder to a maximum length to minimize and/or remove any tension at the tension cable from the tension adjusting component.

In another embodiment, the step of disconnecting the second end of the tension adjusting component from the hub further includes disconnecting control cables and hydraulic lines extending from the hub to the tension adjusting component. The tension adjusting component is also mechanically de-coupled from the hub by removing a pin connection between these elements.

In a further embodiment, none of the steps of the method require an additional crane moved to the wind turbine and that would be capable of lifting components between the ground surface and the hub of the wind turbine. Thus, significant delays and costs associated with use of such large cranes are avoided.

In yet another embodiment, the method also includes performing maintenance and/or repair actions on the tension adjusting component at a location offsite from the wind turbine. This step allows continued operation of the wind turbine with the replacement tension adjusting component without operational downtime during the performing of maintenance and/or repair actions.

The elements and steps described herein can be reconfigured and combined in many different combinations to achieve the desired technical effects for different styles of cable-supported wind turbines and different repair methods, as may be needed in the art

### BRIEF DESCRIPTION OF THE DRAWINGS

The accompanying drawings, which are incorporated in and constitute a part of this specification, illustrate one or more embodiments of the invention and, together with a general description of the invention given above, and the detailed description given below, serve to explain the invention.

FIG. 1 is a diagrammatic front view of an exemplary wind turbine including a cable-supported rotor with a cable support assembly.

FIG. 2 is a diagrammatic front view of the wind turbine of FIG. 1, showing additional details of the cable support assembly.

FIG. 3 is a schematic front cross-sectional view of an exemplary cable tension system for controlling tension in the cable support assembly of FIGS. 1 and 2, taken along the hub of the wind turbine and specifically showing a plurality of tension adjusting components.

FIG. 4 is a diagrammatic front view of the top portion of the wind turbine, showing a first step of a method for replacing a tension adjusting component according to the present invention.

FIG. 5 is a diagrammatic front view similar to FIG. 4, showing a further step of the method including raising a service lift.

FIG. 6 is a diagrammatic front view similar to FIG. 5, showing another step of the method including disconnecting a tension cable.

FIG. 7 is a diagrammatic front view similar to FIG. 6, showing a further step of the method including securing the tension cable.

FIG. 8 is a diagrammatic front view similar to FIG. 7, showing another step of the method including disconnecting the tension adjusting component and beginning to lower it using a hoisting device located within the hub of the wind turbine.

FIG. 8A is a diagrammatic side view similar to FIG. 8, showing the same step of the method but implemented with an alternative hoisting device in the form of a jib crane mounted to the nacelle of the wind turbine (and before the connection and lowering of the tension adjusting component).

FIG. 9 is a diagrammatic front view showing an entirety of the wind turbine, and specifically illustrating a further step of the method including positioning the tension adjusting component into a transport vehicle at a base of the wind turbine.

FIG. 10 is a diagrammatic front view similar to FIG. 9, showing another step of the method including beginning to lift a replacement tension adjusting component from the transport vehicle at the base of the wind turbine.

FIG. 11 is a diagrammatic front view similar to FIG. 8, showing a further step of the method including re-positioning and re-securing the tension adjusting component at the hub of the wind turbine.

FIG. 12 is a diagrammatic front view similar to FIG. 11, showing another step of the method including repositioning a tension cable.

FIG. 13 is a diagrammatic front view similar to FIG. 12, showing a further step of the method including resecuring the tension cable to the replacement tension adjusting component.

FIG. 14 is a diagrammatic front view similar to FIG. 13, showing another step of the method including lowering the service lift.

FIG. 15 is a diagrammatic front view similar to FIG. 14, showing a further step of the method including re-tensioning the cable support assembly.

### DETAILED DESCRIPTION

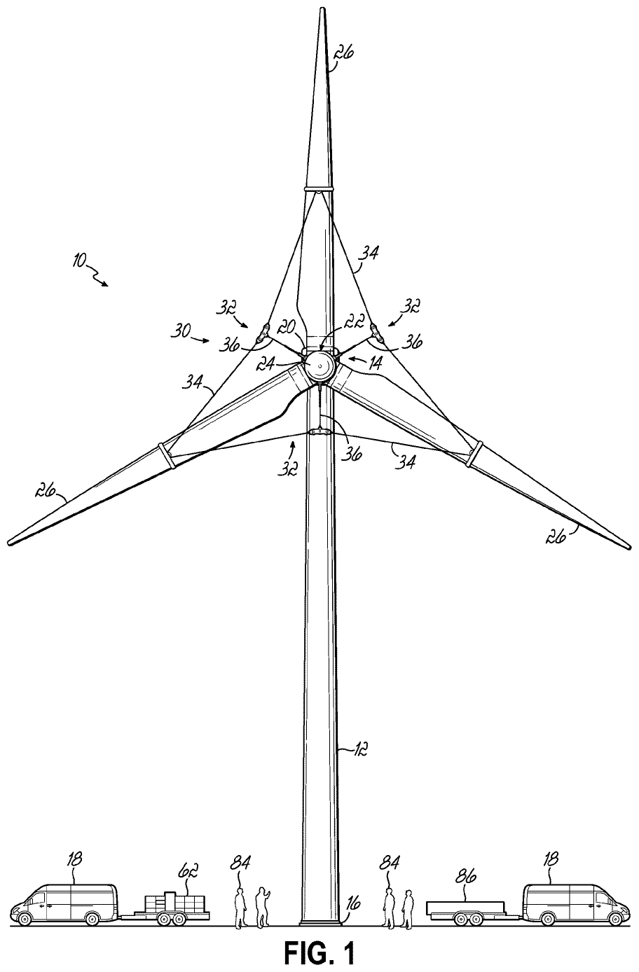

With reference to FIGS. 1 through 15, embodiments of a method for performing maintenance or repair of a cable support assembly (specifically on a tension adjusting component thereof) associated with a cable-supported rotor of a wind turbine are shown in detail, along with an exemplary cable-supported wind turbine. The cable support assembly on the wind turbine as shown includes an active cable tension system which ensures proper cable tension in all situations during the lifetime of the wind turbine. For example, the cable tension system may be configured to apply an initial tension force in the cables before operation and to sustain a generally linear relationship between cable tension and displacement, i.e., a spring-like characteristic, thereby to better support all of the loads applied by operation of longer, larger wind turbine blades. As shown in the embodiments of these Figures, the various support cables are tensioned by applying tension force specifically adjusted and set by a respective tension adjusting component connecting center cables to the hub. Thus, it will be readily understood that the tension adjusting components must be kept in good working order for the cable support assembly to perform its intended function and keep the wind turbine operating in proper condition. The method of the present invention allows for replacement of any one of these tension adjusting components when repair or maintenance is needed on that component, advantageously without necessitating the use of large offsite equipment such as a crane moved to the wind turbine. As will be described in further detail below, such a method is enabled at least in part by use of a hoisting device located within the hub so that the tension adjusting component, which may be quite large in size and heavy in weight in some installations, can be lowered from the top of the wind turbine and a replacement component can immediately be raised back into position. Such an arrangement avoids the need for costly outside crane usage while also minimizing operational downtime because all repairs of the tension adjusting component can occur in a workshop offsite from the wind turbine (while the wind turbine continues operations with the replacement tension adjusting component in place).

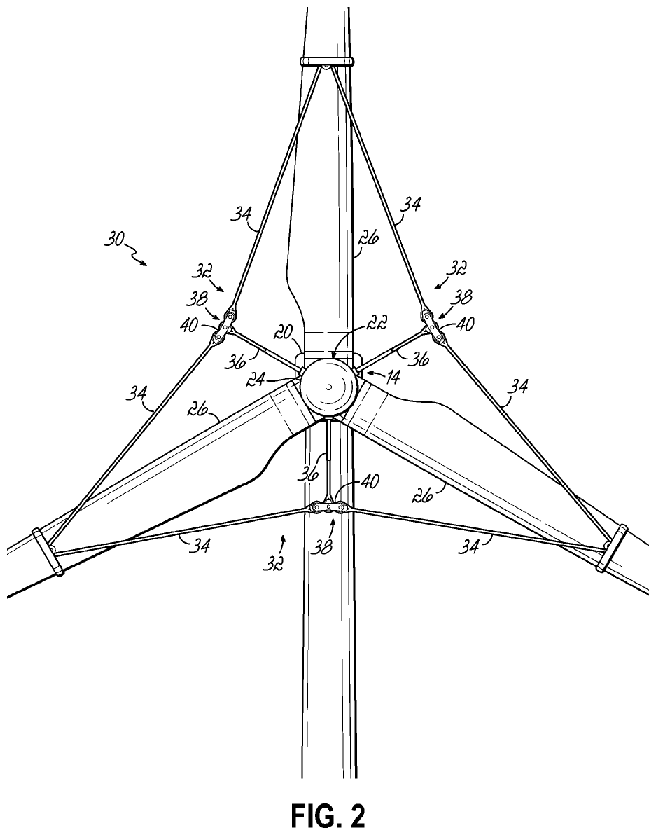

Turning now to FIGS. 1 and 2, these drawings depict an exemplary wind turbine 10 including a tower 12 and an energy generating unit 14 disposed at the apex of the tower 12, the wind turbine 10 being a cable-supported wind turbine that is one example of the type of wind turbine where the method described herein is helpful. The following description now provides relevant background context on the environment and primary components of such a cable-supported wind turbine where the method of the present invention is operated.

The tower 12 is coupled to a foundation 16 at a lower end thereof, shown specifically along a ground surface in FIG. 1. The foundation 16 may be a relatively large mass formed from concrete, steel, etc., that transfers forces acting on the wind turbine 10 into the ground surface. In an alternative embodiment, the foundation 16 may include a pile or other structure at an offshore location to which the wind turbine 10 is attached.

The tower 12 is configured to support the weight of the energy generating unit 14 and elevate the energy generating unit 14 to a height above ground level or sea level at which faster moving air currents of lower turbulence are typically found. Also shown at the ground surface in FIG. 1 adjacent the foundation 16 are support vehicles 18 (shown as vans with trailers, although other versions of vehicles may be used as will be readily understood in this field) that carry a service lift 62 (as a blade access system) and storage boxes 86 that initially contain a replacement tension adjusting component, as will be described further below. The support vehicles 18 can also carry support technicians or other personnel 84 to the site of the wind turbine requiring the maintenance/replacement action, as shown in FIG. 1.

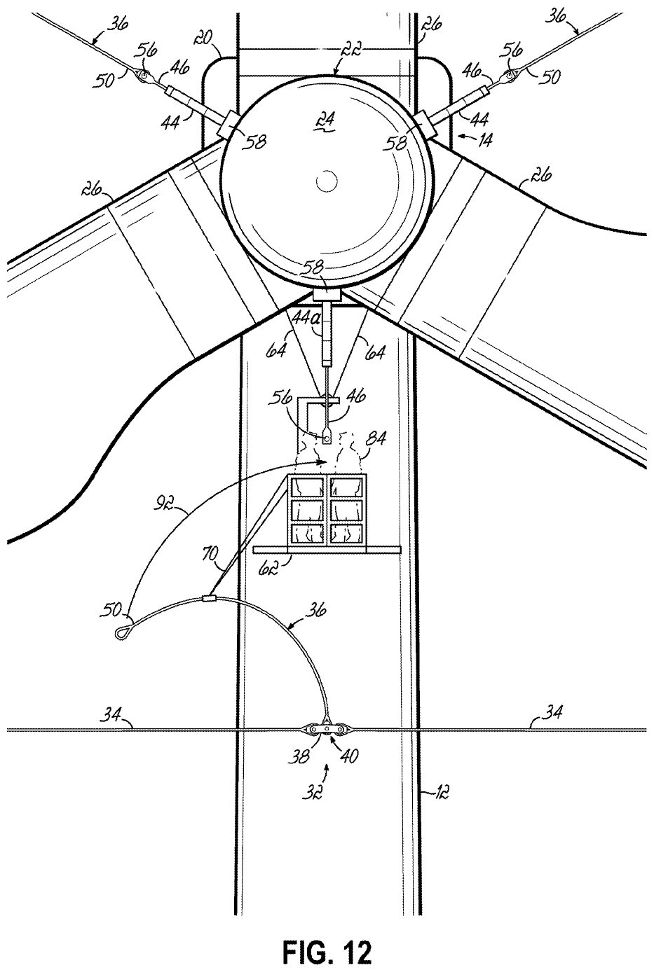

The energy generating unit 14 includes a nacelle 20, a cable-supported rotor 22, and a generator (not shown). The rotor 22 includes a central hub 24 and a plurality of wind turbine blades 26 (e.g., three blades) that are operatively coupled to the hub 24. Each blade 26 may extend from a root end to a tip end, with the root end being coupled to the hub 24 through a pitching system or the like. The pitching system selectively rotates (or “pitches”) each blade 26 about a pitch axis thereof to adjust their angle of attack with respect to the wind. The energy generating unit 14 is typically coupled to the tower 12 by a yaw system (FIG. 12) that rotates the energy generating unit 14 relative to the tower 12 so that the rotor 22 is pointed in an optimum direction with respect to the incoming wind.

The rotational position of the rotor may be referred to as the azimuth of the rotor 22. By way of example, the position of the rotor 22 shown in FIGS. 1 and 2 depicts the tip of one blade 26 at the apex of its path around the rotor's axis of rotation. If this rotor position is considered as an azimuth of 0 degrees, then, for the depicted three-blade rotor 22, the rotor azimuth when the tip of the next blade 26 reaches its apex would be about 120 degrees, and the rotor azimuth when the tip of the next blade 26 after that reaches its apex would be about 240 degrees. It will be understood that more or fewer blades may be provided in other embodiments of wind turbines with cable support assemblies as may be used with the methods of the present invention.

The generator is operatively coupled to the hub 24, e.g., by a drive train including a gear arrangement that interconnects the rotor 22 and the generator. The rotational speed of the generator is typically a fixed multiple of the rotational speed of the rotor 22. Thus, the speed of the generator can be determined from the speed of the rotor, and vice-versa. The generator and a substantial portion of the drive train may be positioned inside the nacelle 20. The generator converts mechanical energy received from the rotor 22 into electrical energy. The blades 26 are configured to interact with the wind in a manner that generates lift. This lift causes the rotor 22 to rotate to generally define a sweep area of the blades 26. The energy generating unit 14 thus generates power from the wind that passes through the sweep area of the rotor 22.

The blades 26 are supported by a cable support assembly 30 that carries as least some of the static and dynamic loads. The cable support assembly 30 transfers these loads between the blades 26 so that the blades 26 mutually support each other. Opposing loads may cancel each other, and some loads may be transferred from the blades 26 to the hub 24. Edgewise loads and flapwise loads are thereby shared among the blades 26 and between the blades 26 and the hub 24 via the cable support assembly 30.

The exemplary cable support assembly 30 of FIG. 1 includes three cable assemblies 32 (one for each pair of blades 26), with each cable assembly 32 being connected to the rotor 22 at three locations. One of these connection points is to the hub 24, and each of the remaining two connection points is to a respective one of two adjacent blades 26. That is, each cable assembly 32 is coupled to and between a respective pair of adjacent blades 26 and to the hub 24. As shown, this forms a Y-shaped cable configuration between the adjacent blades 26 and hub 24. Although not shown in detail, the connection between the cables of each assembly 32 and the rotor 22 may be by way of cable end fittings commonly used in the industry. For example, a thimble with an integrated bearing may define one or more cable ends in each assembly 32. The cable end fittings may cooperate with other fittings or receptacles on the hub 24 and/or on the blades 26 to mechanically attach the assembly 32 so that it carries a portion of the loads on the rotor 22.

Each of the blades 26 may include a cable-to-blade connection point to which the cable assemblies 32 are coupled. The connection points on the blades 26 may be arranged at a distance midway between the root end and the tip end, e.g., at a distance between 10% and 60% of the length of the blade 26 from the root end. In cases where the blades 26 are assembled from separate sections (e.g., an inboard section including the root end and an outboard section including the tip end), the inboard section and the outboard section may be connected at a split position. Blade connection points may be preferably located on or proximate to the pitch axis of the blade 26 to reduce interaction between blade pitch and tension in the cable assemblies 32.

In the depicted embodiment, each cable assembly 32 includes two tip cables 34 that are connected to one another and to the blades 26, and a center cable 36 that is connected to the two tip cables 34 and the hub 24. Thus, each cable assembly 32 includes three separate cables corresponding to each portion of the Y-shaped cable assembly 32. Each of the tip cables 34 and center cable 36 are coupled together at an intersection point 38. Each intersection point 38 may include a connector 40 to which one end of each cable of the respective cable assembly 32 is operatively coupled. One or more of the ends of the tip cables 34 and center cable 36 may include a thimble configured to connect to connection points on the hub 24, blade 26, and/or connector 40, respectively. In an alternative embodiment, the tip cables 34 may be manufactured as one unit, with each end of the unit being operatively coupled to a blade connection point on a respective blade 26. In another embodiment, the tip cables 34 and center cable 36 may be manufactured as one unit (e.g., a Y- or T shaped cable with three ends), with each leg of the unit forming one of the tip cables 34 and the center cable 36, respectively.

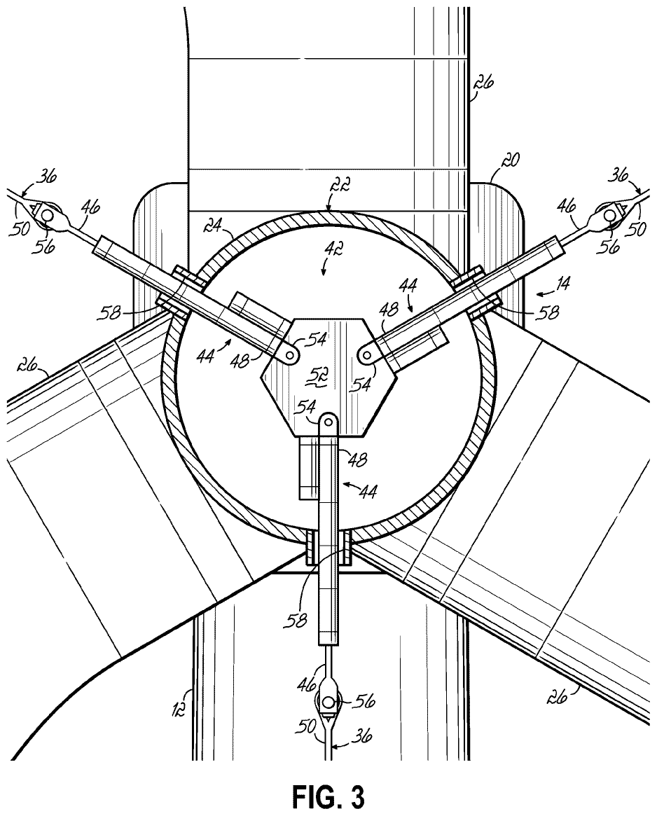

Each cable assembly 32 may be taut in its attachment between the hub 24 and the blades 26. Tensioning the cable assemblies 32 may be achieved using a cable tension system 42. The cable tension system 42 may be located in or adjacent the hub 24 and may include one or more tension adjusting components 44 configured to pull on one or more of the center cables 36 following installation of the cable assemblies 32. Pulling on the center cable 36 in a direction toward the hub 24 places tip cables 34 and center cables 36 in tension so that the cable assemblies 32 transmit loads imposed on the blades 26 as described above. In the simplified view of FIG. 2 focusing on the overall cable support assembly 30, the tension adjusting components 44 are not shown in detail, but these elements and their connection to the center cables 36 are now described with reference to FIG. 3.

In this regard, FIG. 3 presents a cross sectional view of the hub 24 illustrating an exemplary cable tension system 42 including a plurality of (e.g., three) tension adjusting components 44. Each tension adjusting component 44 of this embodiment is an elongated hydraulic cylinder that includes a distal end 46 and a proximal end 48. The distal end 46 of each tension adjusting component 44 is operatively coupled to a proximal (free) end 50 of a respective center cable 36, e.g., such as by a thimble and pin arrangement (hereinafter referred to as cable connection 56). The proximal end 48 of each tension adjusting component 44 is operatively coupled to an anchor point 52 located within or proximate to the hub 24, e.g., by a ball joint 54 or other type of bearing that allows the tension adjusting component 44 to pivot with respect to the anchor point 52. The tension adjusting component 44 extends through a radial opening 58 formed in the hub 24 between the distal and proximal ends 46, 48 as shown in FIG. 3. Each tension adjusting component 44 is configured to apply a selectable amount of force to the center cable 36 (by operating to extend or retract in length between the anchor point 52 and the connection to the center cable 36), thereby enabling individual adjustment of the tension in each cable assembly 32. The anchor point 52 may “float” in the sense that it is allowed to move within certain limits. This movement may facilitate load sharing and balancing among the center cables 36 during operation of the wind turbine 10. In an alternative embodiment, the anchor point 52 may be fixed to the hub 24 so that when unequal forces are applied to the anchor point 52 by the tension adjusting components 44, at least some of these forces are transferred to the hub 24. Although this embodiment of the wind turbine 10 includes hydraulic cylinders as the tension adjusting component 44, it will be understood that other tensioner elements may be used in other embodiments—while still requiring replacement according to the method described herein—including, but not limited to, smaller cylinders (electrical, pneumatic, or hydraulic), electrical actuators, winch systems, and/or combinations thereof.

The tension adjusting components 44 may form part of the hub 24 and be oriented generally radially about the rotational axis thereof. In accordance with one embodiment, the anchor point 52 may be operatively coupled to the hub 24 by an extended hub structure (e.g., a tripod or beam—not shown) that extends outward from the hub 24 along the rotor's axis of rotation. The extended hub structure may locate the anchor point 52 so that it is offset axially in a windward direction from the rotational plane of the rotor 22. This axial offset may enable the cable assemblies 32 to provide support to the blades 26 that counteracts forces (e.g., flapwise forces) applied to the blades 26 by the wind, which also enhances the stiffness of the rotor 22. The anchor point 52 is common and shared by all tension adjusting components 44, and it will be appreciated that this anchor point 52 may be “floating” in the sense that it is allowed to move within the hub 24 to a certain extent, thereby obtaining load sharing and balancing among the cable assemblies 32 as desired. Each tension adjusting component 44 may include one or more linear actuators, such as a hydraulic, electrical, pneumatic, or mechanical actuator, configured to apply a selective amount of tension to the center cable 36—to this end, the specific type of tension adjusting component 44 may vary in other embodiments while remaining within the scope of the methods of this invention.

In operation, the tension adjusting components 44 may be configured to balance tension between each cable assembly 32 of the cable support assembly 30. The tension adjusting components 44 may also provide stiffness and damping characteristics that optimize functionality of the cable support assembly 30. When necessary for servicing (e.g., for service of a blade pitch system) or during installation, the tension provided by the tension adjusting components 44 can be relieved to remove any tension placed on the pitch system or other blade components by the cable assemblies 32. If permanent elongation of the cables occurs (sometimes referred to as “creep”), the cable tension system 42 may be used to retighten the cable support assembly 30 so that it maintains load alleviation according to design specifications. Thus, as noted above, the tension adjusting components 44 of the cable tension system 42 are typically connected to and operated by a main controller (not shown) of the wind turbine 10.

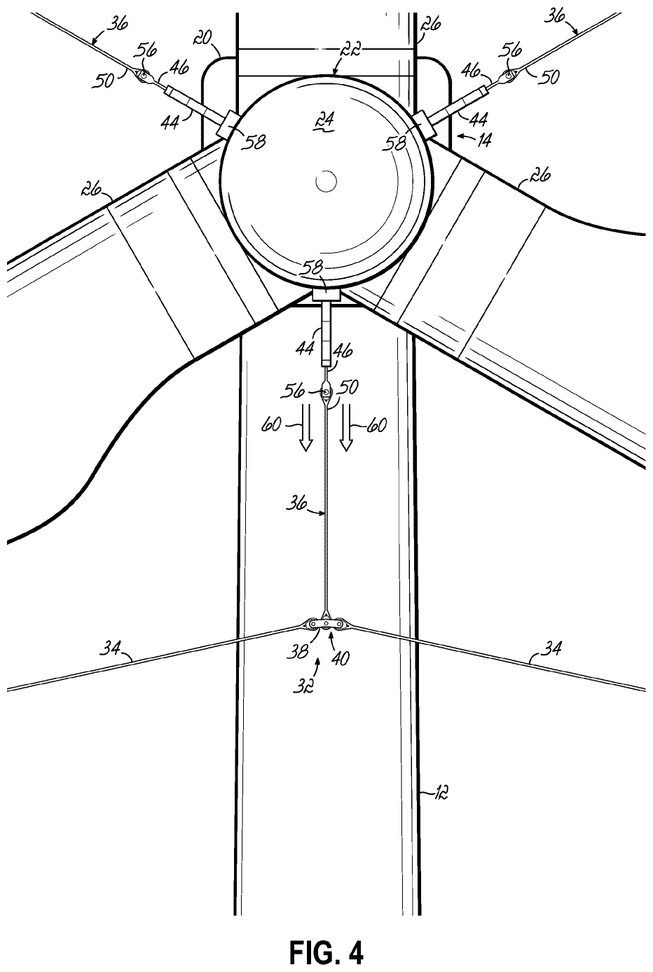

Having described the general context of one embodiment of a cable-supported wind turbine 10 including such tension adjusting components 44, an embodiment of a method for replacing one of the tension adjusting components 44 is now described in detail with reference to FIGS. 4 through 15. After periods of operation, one of the tension adjusting components 44 (when provided as a hydraulic cylinder, for example) may develop a leak or other damage/wear that adversely affects the ability of the tension adjusting component 44 to apply desired amounts of tension force to the connected parts of the cable support assembly 30. It can be difficult and costly to try and repair such damages up tower, such as by rope access technicians. The method now described in detail instead replaces the faulty tension adjusting component so that the wind turbine 10 can continue to operate with a replacement component while any repair or remediation actions are taken at an offsite workshop or other location.

When the method of replacing one of the tension adjusting components 44 is to be done, support technicians 84 and the necessary components can be delivered to the foundation 16 of the wind turbine 10 as shown in FIG. 1, specifically by support vehicles 18 such as the vans pulling the trailers at the bottom of this view. In the example shown, one of the support vehicles 18 transports a service platform 62 (specifically a service lift 62), while the other of the support vehicles 18 transports a pair of storage boxes 86. One of the storage boxes 86 contains the replacement tension adjusting component 44a as will be set forth in further detail below. It will be understood that more or fewer support vehicles 18 and transport vehicles of various types may be used in other embodiments consistent with this method.

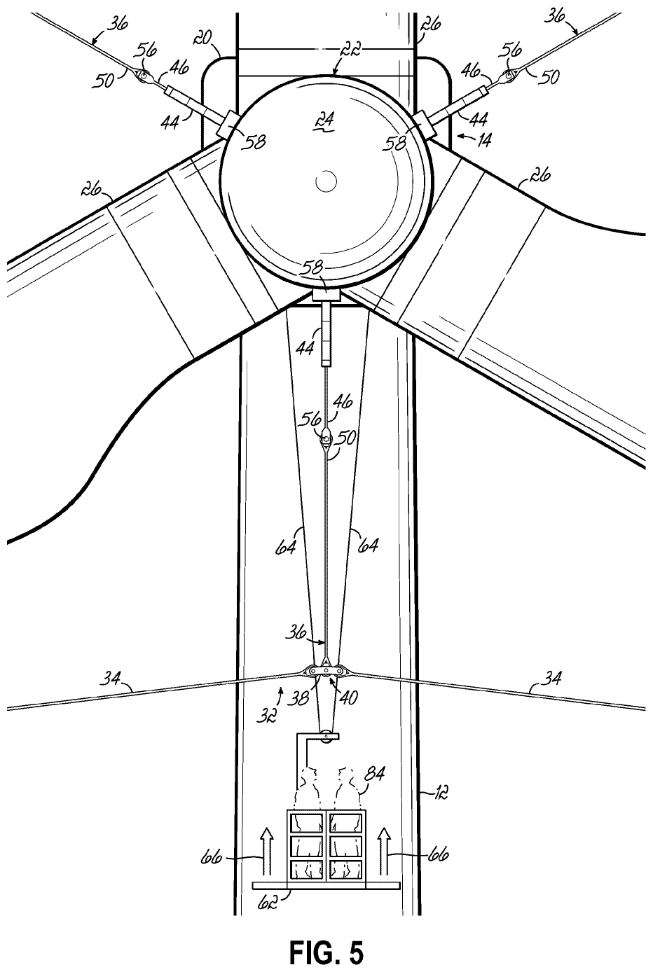

The method can then begin as shown in FIGS. 1 and 4, with the azimuth of the rotor 22 being set so that the tension adjusting component 44 to be replaced extends generally downwardly and vertically from the hub 24, towards the ground surface. This orientation of the rotor 22 and the tension adjusting component 44 positions these elements for the following steps of the method (e.g., for operations of the hoisting device 72). The tension is released in the cable support assembly 30 as shown by arrows 60 in FIG. 4. To this end, the hydraulic cylinder 44 that defines the tension adjusting component 44 may be extended in length, such as to a maximum length, to add slack to the cable assembly 32 along this side of the cable support assembly 30. Moreover, the pitch of one or more of the wind turbine blades 26 can also be adjusted to help in the release of tension forces in the cable support assembly 30. It will be understood that any other known methods of adding slack or releasing tension can be used as alternatives or in conjunction with these mentioned. The release of tension can be seen by the connector 40 moving downward between FIG. 4 and FIG. 5 illustrations. Accordingly, the elements along this portion of the cable support assembly 30 can then be safely disconnected from one another without having any of these elements pulled by tension forces in an uncontrolled manner.

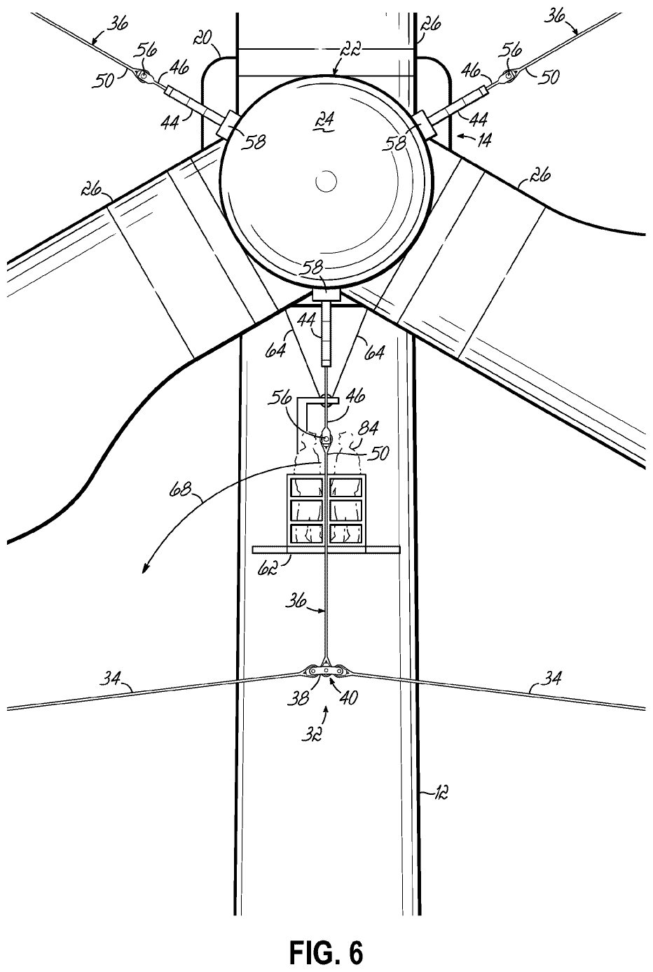

Continuing to FIG. 5, the service platform 62 (also referred to as service lift 62) is then lifted into position. The service lift 62 is a known device used as a blade access system for carrying support technicians 84 and other similar personnel/operators up to the nacelle 20 or other portions at the top of the wind turbine 10. In the example shown, support cables 64 are dropped from the nacelle 20 to the ground surface and secured to a support arm extending generally at the top of the service lift 62. The support cables 64 are operated/controlled from the nacelle 20, such as by additional support technicians located up tower. The support cables 64 move the service lift 62 upwardly as shown by movement arrows 66 in FIG. 5 until the service lift 62 reaches a position proximate the free end or distal end 46 of the tension adjusting component 44. The service lift 62 typically includes engagement structures (such as a C-shaped arm) for engaging and following along the tower 12 during this movement. Such positioning is shown in FIG. 6 when the lifting of the service platform 62 is completed, and as can be readily seen, the support technicians 84 are conveniently positioned to take actions according to the next steps of the method being described. The service lift 62 is thereafter held in the desired position by each of the support cables 64 from the nacelle 20 as well as by the tower 12.

In one alternative embodiment, the service lift 62 may be replaced by another support such as a service platform dropped downwardly from the nacelle 20, or a tall boom lift apparatus (e.g., “cherry picker” lift)—the blade access system can take varying alternative forms, each of which would still be understood to provide a “service platform” according to this invention. To this end, as long as a support is provided (without necessitating a large crane) for a support technician to perform the next-described steps at the cable connection 56 and thereabouts, the particular support does not matter relative to the method. Indeed, a rope access technician approach may also be used in still other embodiments. However, in the embodiment illustrated in these Figures, no significant additional elements need to be stored in the nacelle 20 between the repair and replacement actions, which may be preferred in some contexts.

Referring still to FIG. 6, the method continues by disconnecting the center cable 36, which is also referred to herein as a tension cable 36, from the free distal end 46 of the tension adjusting component 44. As the tension forces have been released from the cable support assembly 30 before this step, the proximal free end 50 of the center cable 36 is generally free to be moved about freely by support technicians 84 on the service lift 62. The cable connection 56 may be held by a simple pin connection or the like, and as such, the support technician 84 can reach and decouple the cable connection 56 to separate these elements from one another. The proximal free end 50 of the center cable 36 can then be moved away from the distal free end 46 of the tension adjusting component 44 as shown by arrow 68 in FIG. 6.

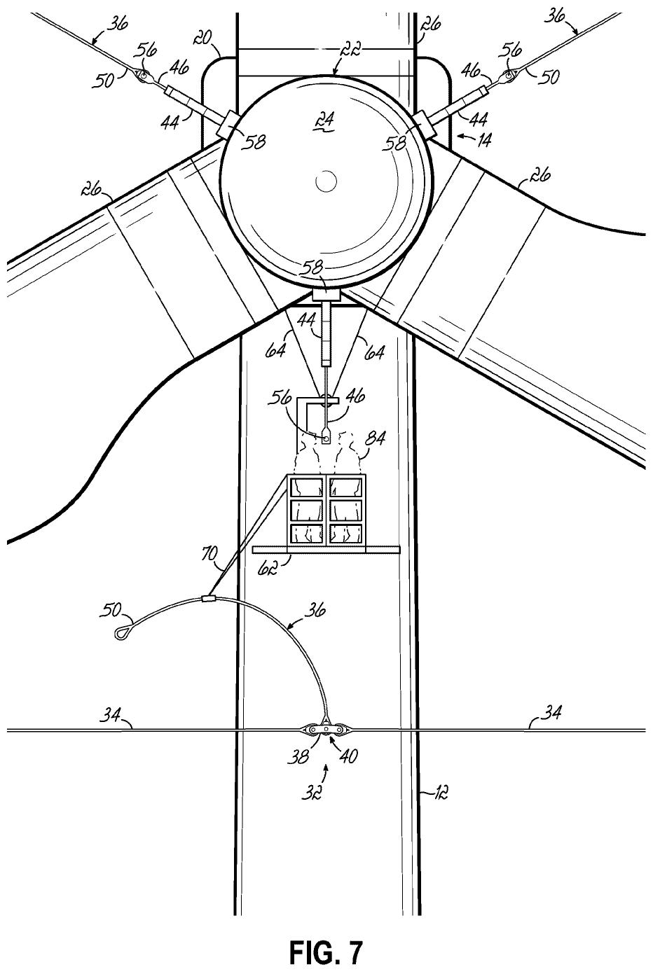

As will be readily understood, these steps free up the tension adjusting component 44 on the distal end 46 located away from the hub 24 so that the tension adjusting component 44 can later be moved for replacement. Turning to FIG. 7, the method continues by securing the center cable 36 to the wind turbine 10. Such a securing can be done in any number of ways. In FIG. 7, securing lines 70 are attached to the center cable 36 (either at the proximal free end 50 or at some portion nearby) and then attached to the service lift 62 or some portion of the wind turbine 10. It may be preferable, in some embodiments, to secure the center cable 36 to the wind turbine 10 so as to separate the support of the tension cable 36 from the service lift 62 (e.g., so as to not accidentally interfere with or otherwise affect the service lift 62). More specifically, the center cable 36 can be secured using the securing lines 70 to either the tower 12 itself, some support (not shown) dropped from the nacelle 20 located immediately above this position, or some other permanent structure of the wind turbine 10. Regardless of the particular support chosen for the securing, the center cable 36 should be maintained in a position where it can be easily retrieved again by the support technician(s) 84 on the service lift 62 when the method continues, and it is time to reconnect these elements together.

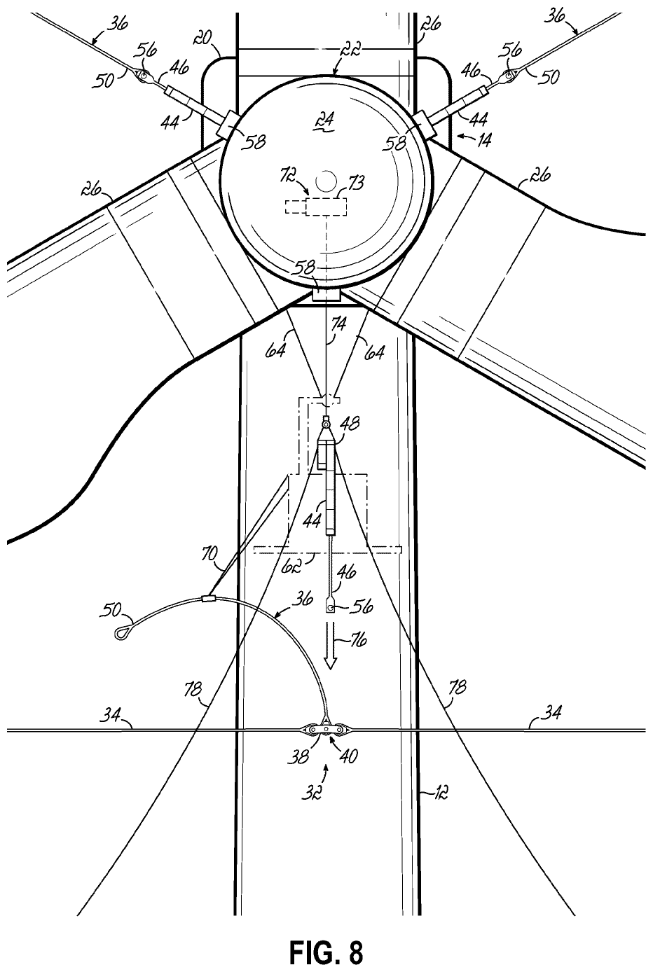

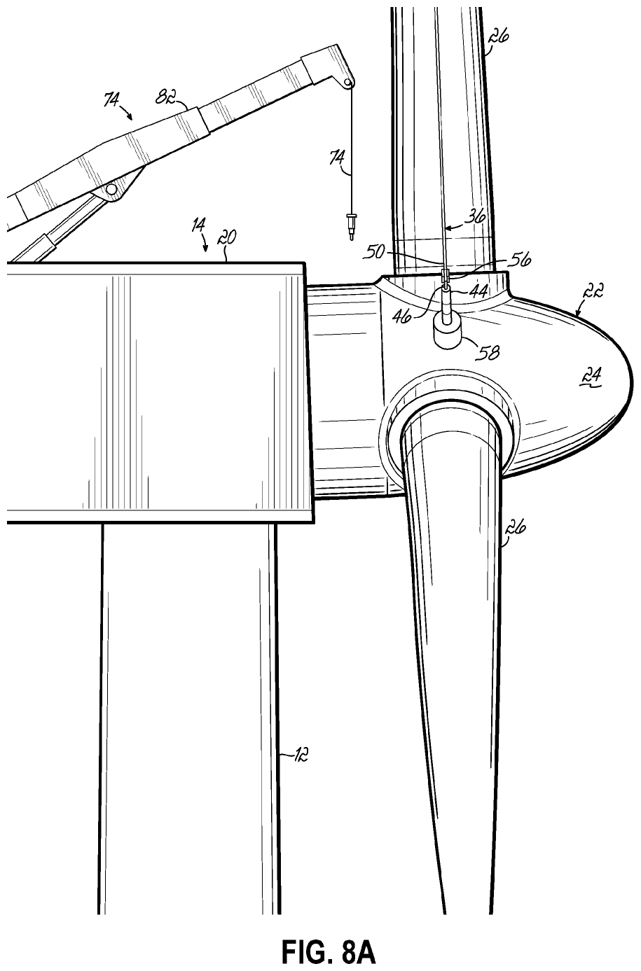

The next steps of the method are carried out generally within the interior of the hub 24, where the support by the anchor point 52 was previously described and shown schematically in FIG. 3. Turning with reference to FIG. 8, the method continues by connecting the second end or proximal end 48 of the tension adjusting component 44 to a hoisting device 72, which in this embodiment is also located within the hub 24 with this proximal end 48. To this end, the hoisting device 72 of this embodiment includes a winch 73 with a lift cable 74 (also referred to as support/movement cable 74) that winds around a spool of the winch 73 when in a stored configuration. The hoisting device 72 may be moved and secured into position (adjacent the radial opening 58) from some other storage location within the hub 24 or the nacelle 20 if it is necessary to store such a component in a different location during normal operations of the wind turbine 10. To this end, the winch 73 may be a permanent installation or may be temporarily secured in a working position as needed, and the positioning of the winch 73 as the hoisting device 72 can vary in other embodiments beyond the one illustrated in detail. Nevertheless, the lift cable 74 is secured at a free end thereof to the tension adjusting component 44 and specifically to the proximal end 48 thereof. The hoisting device 72 may have variations in form and components in other embodiments, so long as the lift cable 74 is provided with sufficient strength to support and move the weight of the tension adjusting component 44 (which can vary from the hydraulic cylinder shown, when other types of tensioner are provided as noted above), and provided with sufficient length to extend between the hub 24 and the ground surface.

One such alternative for the hoisting device 72 is shown at FIG. 8A, for the sake of further clarity. In this regard, the wind turbine 10 may be equipped in certain embodiments with a jib crane 82 that may be permanently installed or temporarily installed onto the wind turbine 10, typically along the nacelle 20. In the example shown in FIG. 8A, the jib crane 82 is mounted on a roof of the nacelle 20 and the boom thereof can be extended and moved into position around the blades 26—and around the other tension adjusting components 44 and cables 36 of the cable support assembly 30 (one of which is visible in the schematic side view of FIG. 8A)—to connect a lift cable 74 (similar to the one described above for the winch 73) to the tension adjusting component 44 as described above (e.g., the one pointed downwardly from the hub 24). However, it will be understood that the jib crane 82 as the hoisting device 72 can be positioned in other locations in further embodiments, including below the nacelle 20 or on a part of the tower 12. To this end, the hoisting device 72 used in conjunction with the following steps of the method may take any of these varying forms, so long as the hoisting device 72 operates the lift cable 74 to move the tension adjusting component 44 as needed in these method steps.

Furthermore, at this step of the method, the proximal end 48 of the tension adjusting component 44 is also disconnected from the hub 24, such as by disconnection at the ball joint 54 from the anchor point 52 described previously. The ball joint 54 may be a simple one-pin connection that is quickly and easily disassembled to release the tension adjusting component 44 for support and movements by the lift cable 74 and winch 73. Any control lines and/or hydraulic supply lines (not shown) extending from the interior of the hub 24 to the tension adjusting component 44 are also disconnected and stowed at this time. Finally, the service personnel performing these actions within the hub 24 also typically secures one or more tag lines 78 to the tension adjusting component 44 and drops such tag lines 78 downwardly so that they can be pulled and controlled by support technicians 84 on the ground surface. The hoisting device 72 is then operated to begin lowering the tension adjusting component 44, specifically moving the second proximal end 48 thereof outwardly through the radial opening 58 as shown by movement arrow 76 in FIG. 8. It will be understood that in some embodiments, additional clearance beyond that provided by the radial opening 58 may be desired during these movements of the tension adjusting component 44, in which case the operators may optionally remove one or more of the fibre shells defining a spinner (covering the hub 24) to allow for such additional clearance during these steps of the method. The tag lines 78 are used to guide and control the movement of the tension adjusting component 44 as the winch 73 lowers it with the lift cable 74.

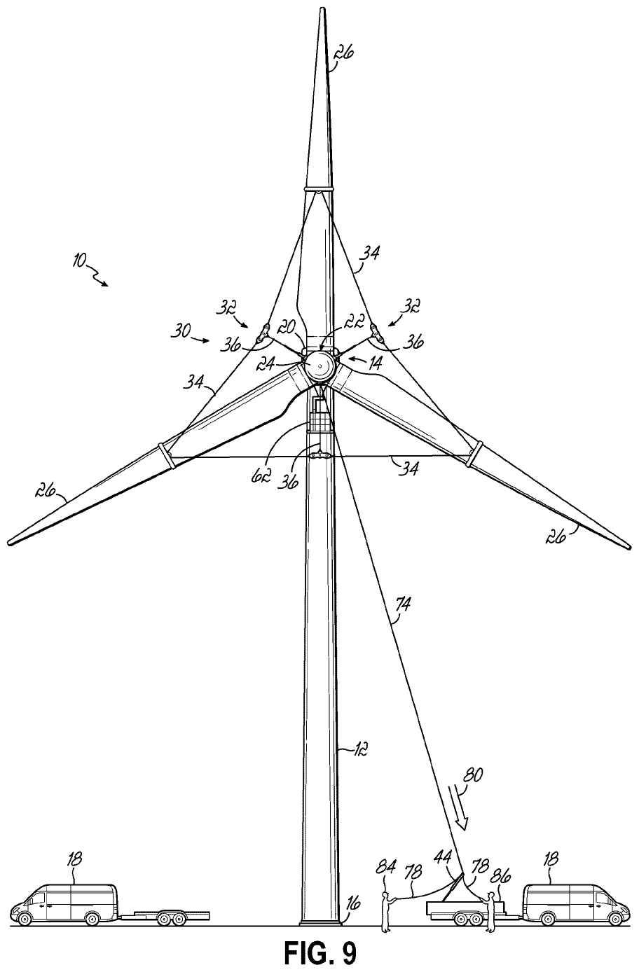

FIG. 9 illustrates a next step of the method, where the hoisting device 72 has continued to lower the tension adjusting component 44 down to the ground surface. By pulling on the tag lines 78, the support technicians 84 on the ground can assure that the tension adjusting component 44 is guided to be dropped into one of the storage boxes 86 at the support vehicles 18 on the ground surface. This movement is shown by the arrow 80 in this FIG. 9. The tension adjusting component 44 can then be ready for transport away from the wind turbine 10 and to an offsite workshop or similar location where maintenance and repair actions (if warranted) can be performed on the tension adjusting component 44. The support technicians 84 on the ground surface will disconnect the lift cable 74 from the tension adjusting component 44 once it has been placed successfully into the storage box 86.

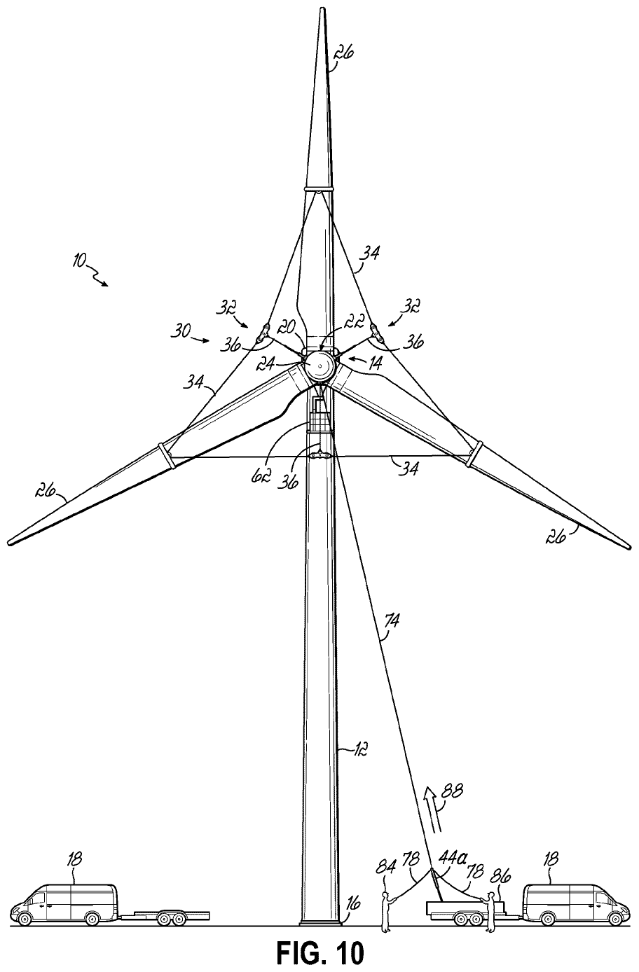

Then turning to FIG. 10, the method continues by connecting a replacement tension adjusting component 44a (of the same form as the one removed) to the lift cable 74 and usually also to the tag lines 78. These connection steps can be done by the support technicians 84 on the ground surface, as they will be in position to do so immediately after disconnecting the original tension adjusting component 44. The replacement tension adjusting component 44a is designated with a different reference number, but the ends 46, 48 thereof and other components are identical, and so these carry the same reference numbers as in prior views. After this connection is completed, the winch 73 is operated by the hoisting device 72 to begin lifting the replacement tension adjusting component 44a out of its storage box 86 and upwardly as shown by arrow 88 towards the hub 24. This lifting movement (with guidance from the tag lines 78, when present) continues until the replacement tension adjusting component 44a is located back at or near the hub 24 and also proximate the service lift 62. It will be understood that the method of replacement now continues with other similar steps in reverse of what was described above.

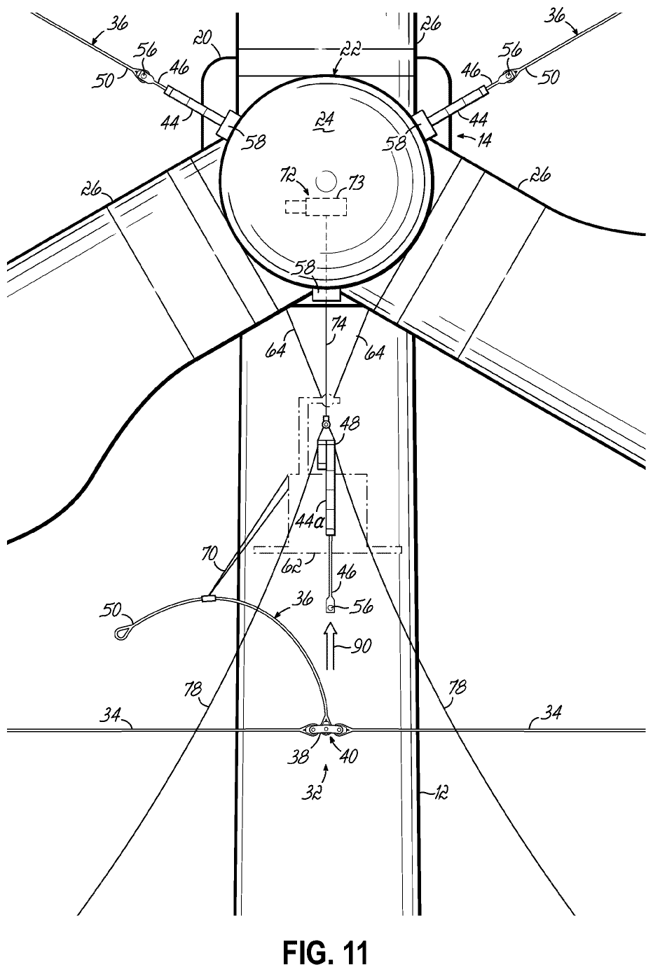

As shown in FIG. 11, the replacement tension adjusting component 44a has been lifted by the hoisting device 72 essentially back to the radial opening 58 in the hub 24. From this position in FIG. 11, the lifting movement continues as shown by arrow 90 until the second proximal end 48 of the replacement tension adjusting component 44a is located back through the radial opening 58 and into the interior of hub 24. This position of the replacement tension adjusting component 44a is shown in FIG. 12, for example. In this position, the control line(s) and hydraulic lines can be reconnected from their stowed position to the replacement tension adjusting component 44a. Moreover, the method can continue by the operator within the hub 24, specifically by securing the second proximal end 48 of the replacement tension adjusting component 44a to the hub 24, such as at the corresponding ball joint 54 on the anchor point 52. As noted previously, this connection at the ball joint 54 may be a simple one-pin style connection that is quick and easy to reassemble. The lift cable 74 of the hoisting device 72 can then be disconnected from this second end 48 of the replacement tension adjusting component 44a because it is once again fully supported by the hub 24. If necessary, the hoisting device 72 can then be moved and stowed away at another location in the hub 24 or nacelle 20.

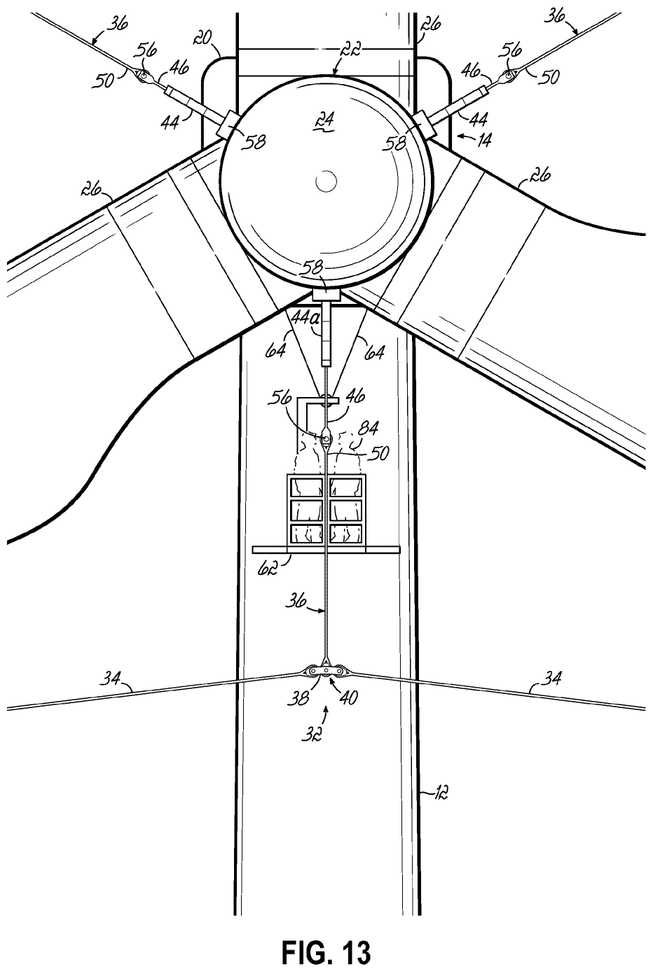

Continuing with reference to FIG. 12, the method continues by having the support technician 84 on the service lift 62 collect the free end 50 of the center cable 36 and remove the securing line(s) 70 from the center cable 36. As the center cable 36 was secured to the wind turbine 10 proximate the service lift 62, the free end 50 is readily positioned to be reconnected to the first free end 46 or distal end 46 of the replacement tension adjusting component 44a. The movement of the center cable 36 in this step is shown by movement arrow 92 in FIG. 12. The cable connection 56 is then reassembled to connect the replacement tension adjusting component 44a back to the center cable 36 and the remainder of the cable support assembly 30, as shown in FIG. 13. The support technicians 84 on the service lift 62 remain well positioned to perform these steps of the method.

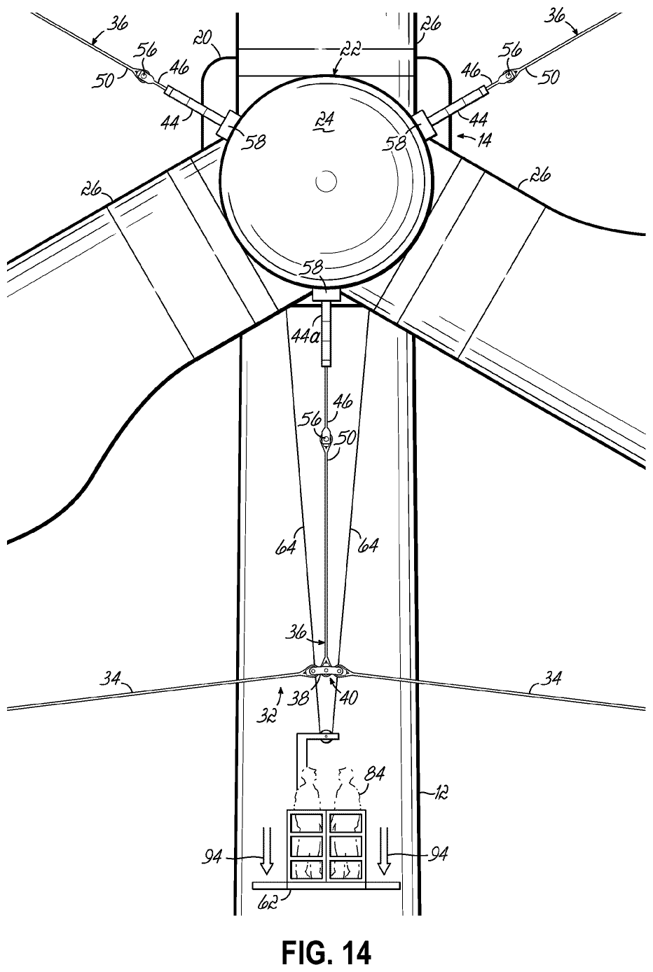

The method then continues with reference to FIG. 14 by removing the service lift 62 from the location proximate the replacement tension adjusting component 44a. In this regard, the support cables 64 from the nacelle 20 can be operated to extend and lower the service lift 62 by controlled movements along the tower 12 back to the ground surface. This movement of the service lift 62 is shown by arrows 94 in FIG. 14, and it returns the support technician(s) 84 back to the ground. Once on the ground surface, the service lift 62 can be disconnected from support cables 64 so that those can be retracted back into the nacelle 20, and then the service lift 62 is placed back on the trailer of one of the support vehicles 18 for movement to another worksite. Of course, it will be appreciated that some wind turbines 10 include auxiliary storage buildings on the ground for maintaining a service platform or lift dedicated to that wind turbine 10, in which case the service lift 62 would be otherwise returned to its storage location and in embodiments with other types of blade access systems/supports, this step involves returning that element to a storage position, wherever that is defined.

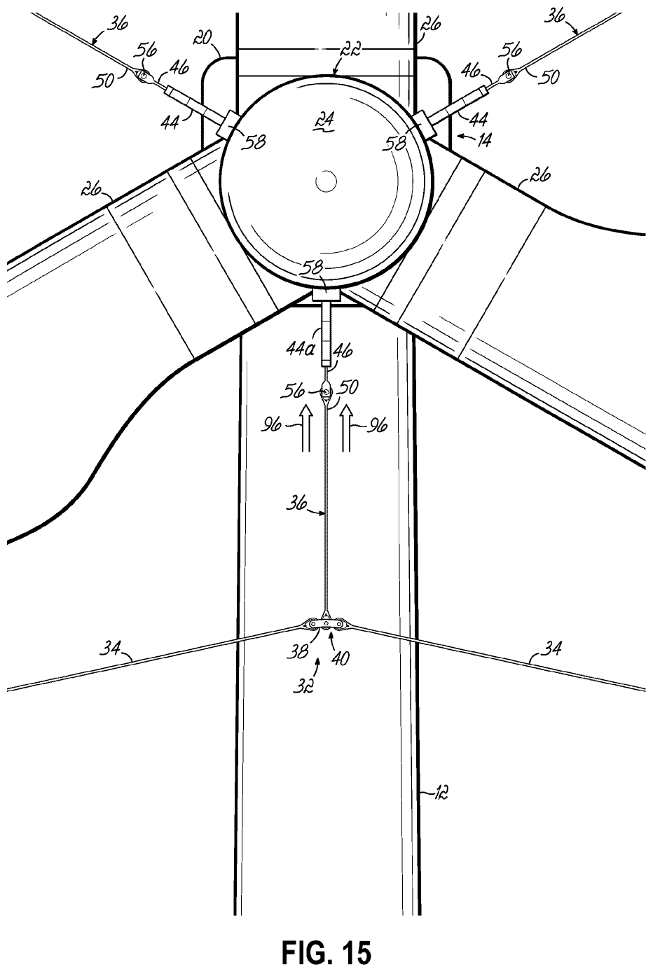

Finally, FIG. 15 shows another step of the method in which the cable support assembly 30 is re-tensioned. In the embodiment illustrated, this re-tensioning can be done by retracting the length of the hydraulic cylinder defining the replacement tension adjusting component 44a to move the proximal free end 50 of the center cable 36 upwardly as shown by movement arrows 96 in FIG. 15. It will be understood that such movement eventually brings the center cable 36 and the corresponding cable assembly 32 back into tension, as was originally the case at the beginning of the replacement method. The controller of the wind turbine 10 within the nacelle 20 may again combine such operation of replacement tension adjusting component 44a with pitching movements of the wind turbine blades 26 and/or other operational steps to precisely adjust and control the tension in the cable support assembly 30 to return to desired levels for supporting the wind turbine blades 26 in continued operations. This step completes the method of replacing the replacement tension adjusting component 44a, at which point the wind turbine 10 can be brought back into full operational mode for generating power from wind energy.

As set forth in the detailed summary of the embodiments above, the method of replacing a tension adjusting component 44 allows for large hydraulic cylinders or any other future-envisioned type of adjusting components (which may be different than hydraulic cylinders and may be smaller in weight and size) to be replaced from their position up tower without necessitating repairs be done at that location. Other than the provision of the hoisting device 72, all the components used in the steps of the method are generally already present or easily provided at the wind turbine 10, thereby reducing costs of making such replacements and repairs. The replacement can also be done without significantly affecting other components of the cable support assembly 30. Moreover, all the steps of replacement are conducted without necessitating a large crane be brought to the wind turbine 10 from offsite, which is expensive and logistically difficult (and therefore not preferred). The method is therefore quite time and cost efficient and allows more operational uptime for cable-supported rotor wind turbines of various designs. The efficiency of the replacement method of the present invention will improve the operations and the maintenance compliance of such wind turbines as this field expands commercially to harvest as much energy from the ambient wind as possible.

While the present invention has been illustrated by a description of various preferred embodiments and while these embodiments have been described in some detail, it is not the intention of the Applicant to restrict or in any way limit the scope of the appended claims to such detail. Additional advantages and modifications will readily appear to those skilled in the art. Thus, the various features of the invention may be used alone or in any combination depending on the needs and preferences of the user.

1. A method for replacing a tension adjusting component included in a cable support assembly connected with a plurality of wind turbine blades on a wind turbine, the method comprising:
rotating a hub and the wind turbine blades such that the tension adjusting component to be replaced extends generally downwardly from the hub towards a ground surface;
releasing tension in the cable support assembly by adjusting the tension adjusting component and/or a pitch of one or more of the wind turbine blades;
disconnecting a tension cable, which connects the cable support assembly to the tension adjusting component, from a free end of the tension adjusting component located away from the hub, and securing the tension cable to the wind turbine;
connecting a second end of the tension adjusting component located within the hub to a hoisting device, and disconnecting the second end of the tension adjusting component from the hub;
lowering the tension adjusting component using the hoisting device down to the ground surface;
connecting a replacement tension adjusting component to the hoisting device at the ground surface, and lifting the replacement tension adjusting component back to the hub using the hoisting device;
securing a second end of the replacement tension adjusting component to the hub of the wind turbine, and a first free end of the replacement tension adjusting component to the tension cable;
disconnecting the hoisting device from the replacement tension adjusting component; and
re-tensioning the cable support assembly.

2. The method according to claim 1, characterized in that the hoisting device includes a winch, with the winch including a support/movement lift cable having a length sufficient to extend between the hub and the ground surface.

3. The method according to claim 2, further characterized by:
selectively mounting and securing the winch inside the hub at a location proximate a radial opening in the hub through which the tension adjusting component extends, to thereby position the winch for connection with and movement of the tension adjusting component.

4. The method according to claim 1, characterized in that the hoisting device includes a jib crane permanently or temporarily connected to the wind turbine, with the jib crane including a support/movement lift cable having a length sufficient to extend between the hub and the ground surface.

5. The method according to claim 1, further characterized by:
positioning a service platform on the wind turbine at a location proximate the free end of the tension adjusting component, specifically before the step of disconnecting the tension cable from the free end of the tension adjusting component; and
removing the service platform from the location proximate the replacement tension adjusting component, specifically after the step of securing the first free end of the replacement tension adjusting component to the tension cable.

6. The method according to claim 5, characterized in that during the step of securing the tension cable to the wind turbine, the tension cable is secured to the wind turbine proximate to the service platform such that operators on the service platform can move and perform this step.

7. The method according to claim 5, characterized in that the service platform is a service lift hoisted up from the ground surface along a tower of the wind turbine by support cables dropped from a nacelle of the wind turbine, the service lift being held in position at the location proximate the free of the tension adjusting component by each of the support cables from the nacelle and by the tower.

8. The method according to claim 5, wherein the step of securing the tension cable to the wind turbine is further characterized by:
attaching the tension cable to at least one of: a tower of the wind turbine, and a support dropped downwardly from a nacelle of the wind turbine at the top of the tower, thereby separating support of the tension cable from the service platform.

9. The method according to claim 1, further characterized by:
securing one or more tag lines to the tension adjusting component and to the replacement tension adjusting component, and further guiding and controlling movement of the tension adjusting component and the replacement tension adjusting component using the one or more tag lines simultaneous to lowering and lifting movements generated by the hoisting device.

10. The method according to claim 1, characterized in that the wind turbine includes a controller at a nacelle adjacent the hub, with the controller operatively connected to each of the wind turbine blades and each tension adjusting component in the cable support assembly, and wherein the steps of releasing tension in the cable support assembly and re-tensioning the cable support assembly are performed by the controller at the nacelle.

11. The method according to claim 1, wherein the tension adjusting component is a hydraulic cylinder that operates to extend or retract in length to apply tension to the tension cable in the cable support assembly, and the step of releasing tension in the cable support assembly is further characterized by:
extending the length of the hydraulic cylinder to a maximum length to minimize and/or remove any tension at the tension cable from the tension adjusting component.

12. The method according to claim 11, wherein the step of disconnecting the second end of the tension adjusting component from the hub is further characterized by:
disconnecting control cables and hydraulic lines extending from the hub to the tension adjusting component; and
mechanically de-coupling the tension adjusting component from an anchor point at the hub by removing a pin connection between these elements.

13. The method according to claim 1, characterized in that none of the steps of the method require an additional crane moved to the wind turbine and that would be capable of lifting components between the ground surface and the hub of the wind turbine.

14. The method according to claim 1, further characterized by:
performing maintenance and/or repair actions on the tension adjusting component at a location offsite from the wind turbine, so as to allow continued operation of the wind turbine with the replacement tension adjusting component without operational downtime during the performing of maintenance and/or repair actions.
